(19) United States
(12) Patent Application Publication
(10) Pub. No.: US 2006/0282679 A1
(43) Pub. Date: Dec. 14, 2006

(54) Secure rapid navigation and power control for a computer

(75) Inventors: Clark D. Nicholson, Seattle, WA (US); Jack Creasey, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/149,590

(22) Filed: Jun. 10, 2005

(51) Int. Cl. H04K 1/00

(52) U.S. Cl. 713/186

(57) ABSTRACT

A user is identified and/or authenticated prior to starting or resuming an installed operating system (OS). The user may rapidly and visually navigate operating systems, user identities, workspaces, and application choices that are valid for the identified user. Moreover, a user may visually navigate the operating systems, user identities, workspaces, applications, and information valid for this user with a single device. Selections may be rapidly activated and changed, along with logout, shutdown, suspension, and hibernation of the computer

### FIELD OF THE INVENTION

The present invention relates generally to the field of computers, and, more particularly, to systems and methods for selecting, receiving, and providing data and other information from and to a user.

### BACKGROUND OF THE INVENTION

Personal computer systems can be configured to support multiple operating systems (OS), multiple user identities, and many applications within each OS/user context (security context). Providing secure authenticated access to the computer and navigating the selection of OS, user context, and applications within a user context can require many user actions to complete. The user has to perform many steps and actions to select and activate choices, and each step or action may require complex interaction with menus and display elements, in addition to keyboard entry. When the user is finally running applications within an operating system instance, he has to start and stop applications focused on particular data files, and this again can be an action intensive process involving menus and data entry. The added complexity on a mobile platform without a keyboard makes rapid navigation and user interaction a critical function. The process of lock, logout, suspend, or hibernate can be just as action intensive.

In view of the foregoing, there is a need for systems and methods that overcome such deficiencies.

### SUMMARY OF THE INVENTION

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

Embodiments of the present invention are directed to identification and/or authentication of a user prior to starting or resuming any installed operating system, and allows the user to rapidly and visually navigate operating systems, user identities, workspaces, and application choices that are valid for the identified user. Moreover, a user may visually navigate the operating systems, user identities, workspaces, applications, and information valid for this user with a single device. According to aspects of the invention, selections may be rapidly activated and changed, along with logout, shutdown, suspension, and hibernation of the computer.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIGS. 1A and 1B are diagrams of an example system in accordance with the present invention;

FIG. 2 is a flow diagram of an example method of user identification and selection in accordance with the present invention;

FIG. 3 is a diagram of an example display that is useful in describing aspects of the present invention; and

FIG. 4 is a block diagram showing an example computing environment in which aspects of the invention may be implemented.

### DETAILED DESCRIPTION OF ILLUSTRATIVE EMBODIMENTS

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Desirably, a user is identified and/or authenticated prior to starting or resuming an installed operating system (OS). The user may rapidly and visually navigate operating systems, user identities, workspaces, and application choices that are valid for the identified user. Moreover, a user may visually navigate the operating systems, user identities, workspaces, applications, and information valid for this user with a single device. Selections may be rapidly activated and changed, along with logout, shutdown, suspension, and hibernation of the computer.

Many types of computer devices have either no keyboard or an on-display keyboard, and these devices require multiple user actions to power up the device, identify/authenticate the user, and select information to display or applications to run. Because of the action intensive nature of the startup processes, there is a tendency for users to disable the authentication processes and leave the device more prone to security compromises.

For computer systems with no physical keyboard and mouse (such as a slate style tablet PC), a system configuration that hides the mouse and keyboard (such as a convertible tablet in slate mode), and/or where all applications are running maximized or full screen, it is difficult to select the application focus (e.g., in Microsoft Windows XP this can be done using an ALT-Tab keyboard shortcut to navigate between applications). An example system in accordance with the present invention provides local user authentication which enables a display and rapid navigation system which can subsequently start an operating system and applications. A rapid navigation system is used to select from an iconic or textual representation of locally held information. Selection of items in a rapid navigation display can be used to power up the computer system and select operating system and applications to be displayed by the computer system.

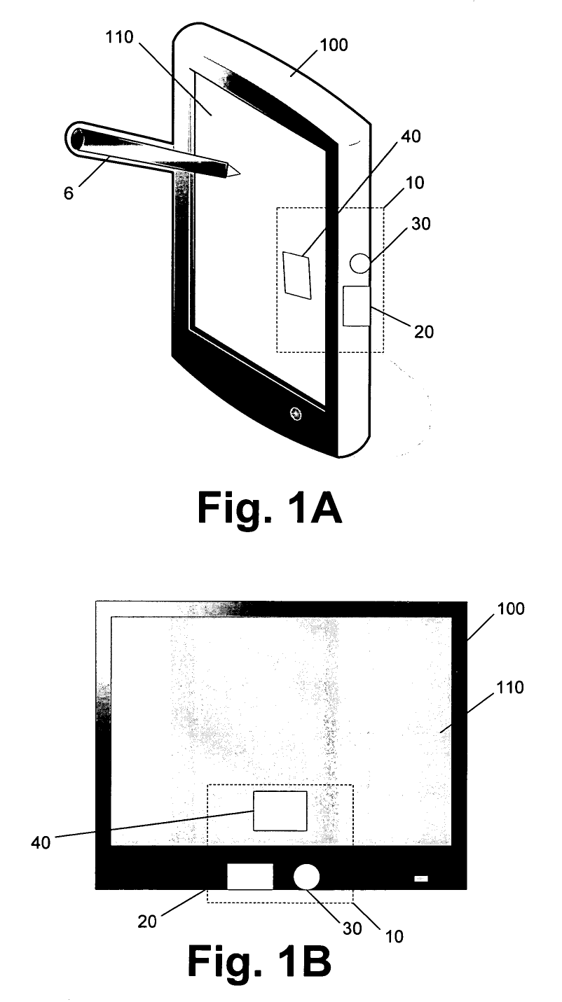

An example system is shown in FIGS. 1A and 1B, and is based on a tablet personal computer (PC) 100 (with stylus 6), although the invention may be implemented in any computing device. The system 10 comprises an identification/authentication device 20, and a navigation device 30, such as a navigation wheel. An auxiliary display 40 is also provided. The system 10 in FIGS. 1A and 1B is shown as being incorporated into a computing device 100, such as a tablet PC, but the system can also be embodied as a standalone device that is disposed remotely from the computing device 100, or plugs into the computing device 100 (e.g., into a USB, Firewire, serial, or parallel I/O port). The system may be controlled by a computer system with local storage.

Moreover, some portions of the system 10 can be incorporated or embedded into the computing device 100 while other portions of the system are separate from the computing device 100, in a standalone device that may plug into the computing device 100, for example. It is also contemplated that the authentication device 20 and the navigation device 30 may be combined into a single device that provides biometric authentication, direction sensing, motion, and selection features, for example. In another example, the power button could also be combined into the device providing a power signal in addition to authentication, motion, and selection features.

The identification/authentication device 20 is used to authenticate individual users, or authenticate and map digits for different selections for a user, for example. The identification/authentication device 20 may be a biometric device, such as a fingerprint reader which will authenticate the user to computing device 100, and in particular, to a local rapid navigation system running on the computing device 100. The rapid navigation system in conjunction with the navigation device 30, for example, permits a user to move or scroll through iconic or textual representations (on the display 40, for example) of security contexts, and schedule and contact information, for example, that this user is permitted to access. Selection of a security context will result in the computer system starting the operating system for that context. The rapid navigation system and display 40 would then display applications and information associated with the user context (e.g., data and applications pertinent to the user).

FIG. 1A and 1B show a main display 110 and an auxiliary display 40 disposed within computing device 100 (e.g., a personal computer (PC), which may be a tablet PC), for example. The auxiliary display 40 is desirably provided as a utility within the main display 110. It is contemplated that the auxiliary display 40 could be a separate display instead of a utility in the PC 100. The display 40 provides iconic and textual information, for example, as described further herein.

Thus, it is contemplated that the auxiliary display 40 used for navigation selections can be a separate display or part of the main display 110. A small auxiliary display may be used to achieve low power operation, and it may be desirable to activate only a small portion of the main display prior to starting an operating system and use a portion of the main display (as the auxiliary display) when the system is fully powered up. Achieving low power may also be possible where new technologies such as OLED displays are used, and/or where the display power is directly related to the number of pixels used. The auxiliary display 40 is used to keep power consumption low. It is not necessarily run by the main computer system. It can be a separate physical device (remote or local) or part of the main display 110. A separate processor can run the auxiliary display 40, or the main processor can run it in low power mode.

Alternatively, for a conventional (e.g., non-tablet) laptop, the auxiliary display may be on the outside of the closed laptop.

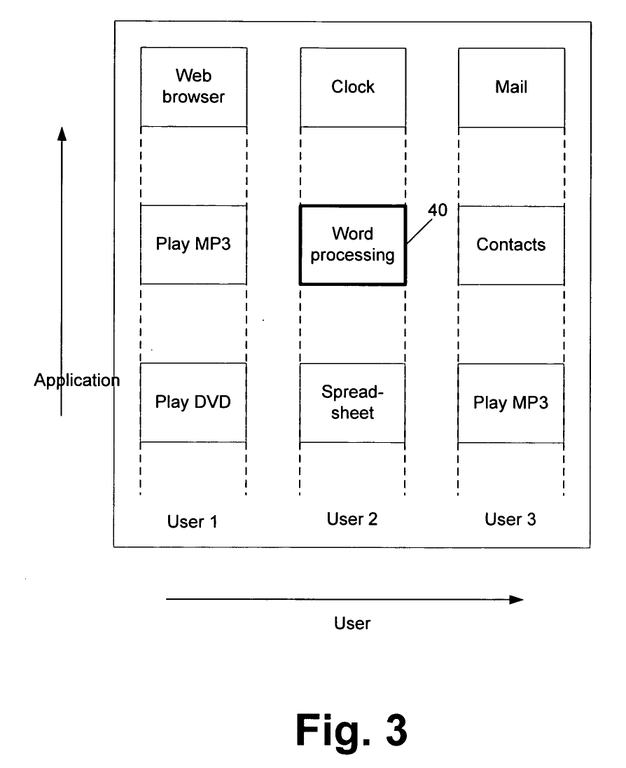

The navigation device 30 may be a navigation wheel. An example navigation wheel may have two degrees of movement. For example, rotation would display options or an information list, and moving the wheel to one side selects an option, while moving the wheel to the other side cancels or moves back to a higher level selection. Furthermore, the navigation wheel may allow for sideways, rotational movement and wheel depress events to trigger navigation and selection. See FIG. 3, for example.

The navigation device 30 thus enables the rapid navigation of iconic or textual information stored locally. The locally stored iconic or textual representation of security contexts and information for individually identified users may be loaded from the computing device 100 operating system into the device 100 (or the device 10 or 30, for example) prior to shut down or hibernation or during active use. User identification icons and text messages allowing selection of multiple user contexts (security contexts) and information such as schedules and contacts can be downloaded for use when the user authenticates.

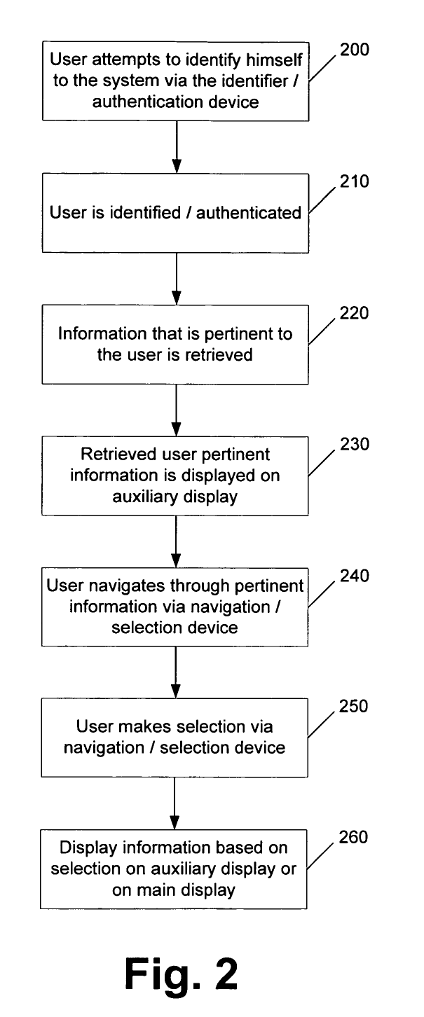

FIG. 2 is a flow diagram of an example method of user identification and selection in accordance with the present invention. Assuming that the PC is in a low power sleep state, it is desirable to identify that a valid authorized user is attempting to access the PC. Preferably, the user authenticates to gain access to the PC and eventually power up an operating system instance and/or applications.

At step 200, a user provides a finger, for example, to the identification/authentication device to identify himself to the system. The device, working alone or in conjunction with another system, desirably identifies and authenticates the user, at step 210, using, for example, conventional identification techniques.

After the user is authenticated, information that is pertinent to the user is retrieved, at step 220, and then displayed on the auxiliary display, at step 230. This first level of data may include a choice of operating systems, a clock display, a meeting schedule, and contacts information, for example. Information that is pertinent to the user may be determined beforehand or on the fly, based on various parameters and/or predetermined conditions, for example.

The user may navigate through the displayed information, at step 240, using the navigation device, for example. As desired, the user may select information from the auxiliary display, at step 250. This information (or applications, files, etc.) related to the selected information is then activated, implemented, or opened. At step 260, further information or data, based on the selection, may then displayed, in the auxiliary display and/or the main display.

For example, if the user desires to view schedule or contacts information, he can navigate through this and then select cancel to lock the computing device when finished. If the user selects an operating system to start, then the PC operating system is started and the display may change to show the available user identities and security contexts to logon to this operating system instance. Selecting a user identity logs into the operating system. For example, the biometric information captured when starting the device is used to validate the user for the OS, thereby reducing the user interaction needed.

After the user is logged into the operating system as a valid user, the navigation system can be used to select either the running application that should have main display focus, or to start any application with main display focus, or focus on any data that will start an application using other methods (such as file association), for example.

Thus, for example, where a tablet PC is used, users typically run applications maximized or full screen, so the user is able to navigate running applications in accordance with the present invention.

If the user rotates the selection wheel on a navigation device, the display may show the icon or text representation of the applications running, and selecting one of these and hitting select will bring this to full screen focus in the main display. If the user selects an item not currently running, then the application is started. If the user selects an application and chooses “cancel” the application is desirably stopped or closed.

Using this type of navigation and selection significantly reduces the number of actions a user must take to get desired applications and information on screen. In addition to the rapid navigation, the security of the device may be improved by ensuring that information is displayed only for a valid user. According to aspects of the invention, identification may be combined with each navigation attempt, thereby providing a near continuous validation method. For example, if anyone other than the authorized user attempts to use the navigation wheel, the operating system desirably locks, thereby preventing access.

It is contemplated that the device implementation may be positioned so that it could be used by either left or right handed users, authentication of the user can be used to configure the display based on the hand or digits used to authenticate.

During active computer use, information on the running or potentially startable applications is desirably downloaded for the user to scroll through and select. This allows the user to set the focus between multiple maximized or full screen applications running in a security context using the rapid selection navigation wheel without using the ALT-Tab keyboard accelerator key sequence, for example.

Information that may be loaded into an exemplary device or system that can permit user navigation and selection to be made of various configurable options in the PC includes user contexts, running applications, start applications, and user information. User contexts may represent separate user identities or security bounded environments such as fast user switching, or virtual machine environment. Running applications may be applications executing in any user context. Start applications may be applications that may be selected to run in a user context. User information may range from user (owner) information to schedules, contacts, or any other information that can be displayed prior to loading the PC operating system, for example.

The operating system desirably provides a management utility that allows the user to define security contexts, applications, and information that can be accessed by a user identified by the authentication processes implemented in the device. For example, a user may create a security context identified by his forefinger fingerprint that starts an operating system for a corporate desktop. A second context may be created that permits access to a DVD or MP3 player using the second finger, and an additional context may be created that may be accessed by any fingerprint that shows only the owner information, for example.

Thus, user authentication, information display, navigation of choices, and selections independent of the primary computer operating system, are integrated. An identified (e.g., authenticated) user may rapidly navigate and select (start) and stop selections. The starting, stopping and focus switching of applications may be maximized or use full screen.

The device may be used pre-OS to identify an OS (for multi-boot systems), a user and provide entry to the OS, and post-OS to allow a user to find a file or application, for example.

FIG. 3 is a diagram of an example display that is useful in describing aspects of the present invention. The applications pertaining to each of three users (user 1, 2, 3) are shown. Each user may have different associated applications. Icons or text are displayed in the auxiliary display 40, and moving the navigation device scrolls through each of the icons (which are desirably displayed in the auxiliary display 40), which may then be selected. For example, user 1 may cycle between “web browser”, “play dvd”, and “play mp3”, whereas user 2 may cycle between “clock”, “word processing”, and “spreadsheet”. Depending on which user authenticates via the identification/authentication device, a different set of applications is desirably displayed in the auxiliary display 40. These applications may be scrolled through and ultimately selected via the navigation device. Additionally, a user may be presented with various selectable power down options, such as shut down, standby, and hibernate.

Alternatively, an application (e.g., word processing, spreadsheet, etc.) could be selected, and then a list of files could be scrolled through by the user. The user may then select a particular file to open in the main display.

Additionally, the user identified here might be a security context. For example, the system may respond to any user identification, such as, if a user attempts to authenticate, the system may use a low security context such as “Guest” to provide only the ownership information.

Example Computing Environment

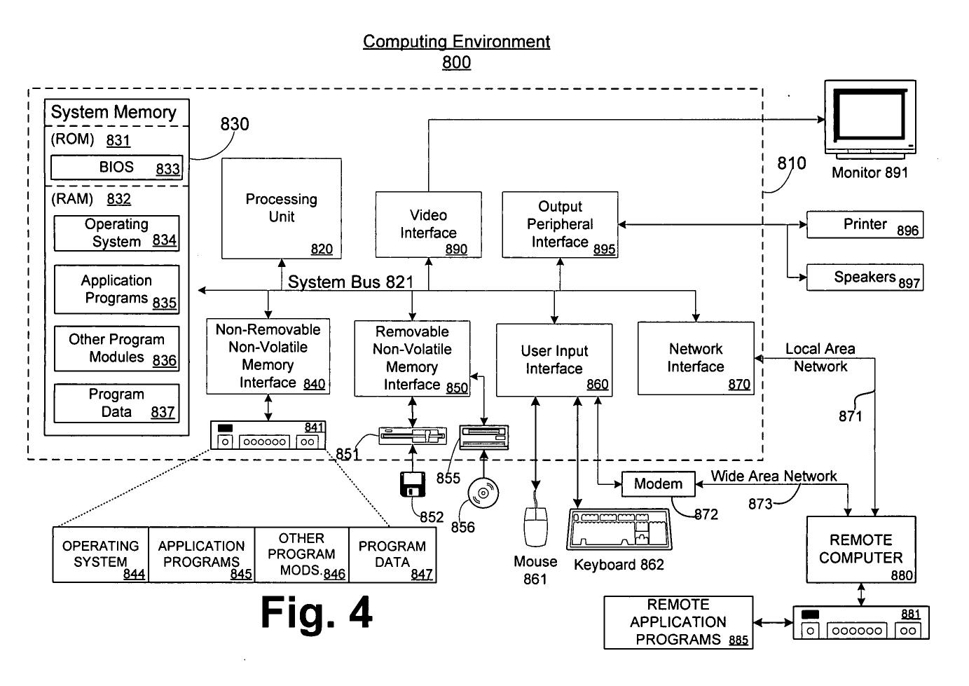

FIG. 4 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 4 thus illustrates an example of a suitable computing system environment 800 in which the invention may be implemented, although as made clear above, the computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

With reference to FIG. 4, an example system for implementing the invention includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), PCI-Express and serial busses such as USB.

Computer 810 typically includes a variety of computer readable media. Computer readable media can be any available media that can be accessed by computer 810 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 830 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 4 illustrates operating system 834, application programs 835, other program modules 836, and program data 837. RAM 832 may contain other data and/or program modules.

The computer 810 may also include other removable/non-removable, volatile/nonvolatile computer storage media. By way of example only, FIG. 4 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 4 provide storage of computer readable instructions, data structures, program modules and other data for the computer 810. In FIG. 4, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus 821, but may be connected by other interface and bus structures, such as a parallel port, game port or a universal serial bus (USB).

A monitor 891 or other type of display device is also connected to the system bus 821 via an interface, such as a video interface 890. In addition to monitor 891, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 4. The logical connections depicted in FIG. 4 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 4 illustrates remote application programs 885 as residing on memory device 881. It will be appreciated that the network connections shown are exemplary and other means of establishing a communications link between the computers may be used.

One of ordinary skill in the art can appreciate that a computer 810 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

What is claimed:

1. A computer navigation and selection system, comprising:
an identifier for identifying a user;
a navigation device for navigating among various data pertinent to the identified user;
a selection device for selecting one of the data; and
an auxiliary display for displaying the various data one at a time pursuant to manipulation of the navigation device.

2. The system of claim 1, wherein the navigation device and selection device are comprised within a component.

3. The system of claim 2, wherein the component comprises a scroll wheel.

4. The system of claim 1, wherein the identifier comprises a biometric sensor.

5. The system of claim 1, wherein the identifier comprises a fingerprint reader.

6. The system of claim 1, further comprising a device for turning on the system, and a selector for selecting an operating system.

7. The system of claim 1, wherein the identifier, the navigation device, the selection device, and the auxiliary display are disposed within a standalone device.

8. The system of claim 1, wherein the identifier, the navigation device, the selection device, and the auxiliary display are disposed within a computing device.

9. The system of claim 8, wherein the computing device is a tablet personal computer, a laptop personal computer, or a handheld computer.

10. A computer navigation and selection system comprising:
a computing system comprising a main display; and
an identification and selection device comprising an auxiliary display.

11. The system of claim 10, wherein the identification and selection device comprises:
an identifier for identifying a user;
a navigation device for navigating among various data pertinent to the identified user;
a selection device for selecting one of the data; and
the auxiliary display for displaying the various data one at a time pursuant to manipulation of the navigation device.

12. The system of claim 10, wherein the computing system is a personal computer, a tablet personal computer, a laptop personal computer, or a handheld computer.

13. The system of claim 10, wherein the identification and selection device is integral with the computing system.

14. The system of claim 10, wherein the identification and selection device is separate from the computing system and in wired or wireless communication with the computing system.

15. The system of claim 10, wherein the auxiliary display is disposed within the main display.

16. A computer navigation and selection method, comprising:
identifying a user at an identification and selection device;
displaying information pertinent to the identified user;
displaying additional information pertinent to the identified user pursuant to receiving navigation signals;
receiving a selection of one of the information and additional information; and
performing an action pursuant to the selection.

17. The method of claim 16, further comprising authenticating the user.

18. The method of claim 16, wherein the selection comprises a power down mode.

19. The method of claim 16, wherein the selection comprises an operating system, and further comprising:
activating the operating system on a computing device; and
displaying selectable information pertinent to the selected operating system.

20. The method of claim 16, wherein the selection comprises an application, and further comprising displaying files pertinent to the application.
